(19) United States
(12) Patent Application Publication
(10) Pub. No.: US 2009/0015169 A1
(43) Pub. Date: Jan. 15, 2009

(54) Method for Driving an LED

(75) Inventor: Yu-Nung Shen, Taipei City (TW)

Correspondence Address: HOUSTON ELISEEVA, 4 MILITIA DRIVE, SUITE 4, LEXINGTON, MA, 02421, US

(73) Assignee: ATC ALTEX TECHNOLOGY CORPORATION, Taipei Hsien (TW)

(21) Appl. No.: 11/776,697

(22) Filed: Jul. 12, 2007

(51) Int. Cl. H05B 37/02

(52) U.S. Cl. 315/185 R; 315/194; 315/195

(57) ABSTRACT

A method for driving a light emitting diode (LED), which is operated at a prescribed constant driving voltage and a prescribed constant driving current such that the prescribed power consumption of the LED in a prescribed unit of time is the prescribed constant driving voltage times the prescribed constant driving current, comprises the step of supplying the LED with a driving pulse signal at a cycle equal to the prescribed unit of time, the driving pulse signal having a peak value equal to n times of current value of the prescribed constant driving current and a high voltage level duration of T/n′, wherein T is the prescribed unit of time, n and n′ both are positive integer excluding 0 and 1, and n/n′≦1, thereby the intensity of the light emitted from the LED can be increased by n times while the power consumption is kept unchanged.

### BACKGROUND OF THE INVENTION

Recently, the tendency of using Light-Emitting Diodes (LEDs) as light source for electronic devices, lighting devices, etc. is continuously increasing. However, in order to completely replace with LEDs the traditional light sources, especially the indoor lighting devices, the intensity of the light emitted by the LEDs must be greatly enhanced.

### SUMMARY OF THE INVENTION

The present invention relates to a method for driving a LED, and more particularly, to a method for driving a LED which can effectively enhance the light intensity of a LED.

The present invention provides a method for driving a LED which can enhance the light intensity of a LED.

One aspect of the present invention is a method for driving a LED which is operated at a prescribed constant driving voltage and a prescribed constant driving current such that the prescribed power consumption of the LED in a prescribed unit of time is the prescribed constant driving voltage times the prescribed constant driving current. This method comprises the step of supplying the LED with a driving pulse signal at a cycle equal to the prescribed unit of time, the driving pulse signal having a peak value equal to n times of current value of the prescribed constant driving current and a high voltage level duration of T/n′, wherein T is the prescribed unit of time, n and n′ both are positive integer excluding 0 and 1, and n/n′≦1, thereby the intensity of the light emitted from the LED can be increased by n times while the power consumption is kept unchanged.

Other aspects and advantages of the present invention will become apparent from the following description, taken in conjunction with the accompanying drawings, illustrating by way of example the principles of the invention.

The above and other features of the invention including various novel details of construction and combinations of parts, and other advantages, will now be more particularly described with reference to the accompanying drawings and pointed out in the claims. It will be understood that the particular method and device embodying the invention are shown by way of illustration and not as a limitation of the invention. The principles and features of this invention may be employed in various and numerous embodiments without departing from the scope of the invention.

### BRIEF DESCRIPTION OF THE DRAWINGS

The invention, together with objects and advantages thereof, may best be understood by reference to the following description of the presently preferred embodiments together with the accompanying drawings in which:

FIG. 1 is a plot of current/voltage as a function of time showing a waveform of a conventional driving current signal for a light-emitting diode (LED);

FIG. 2 is a plot of relative brightness as a function of current showing the relationship between the brightness of a LED and the magnitude of driving current;

FIG. 3 is a plot of current as a function of time showing a waveform of a driving pulse signal used in a method of driving a LED according to the present invention;

FIG. 4 is a plot of current as a function of time showing an exemplary example of a waveform of a driving pulse signal used in the method of driving a LED according to the present invention;

FIG. 5 is a plot of current as a function of time showing another exemplary example of a waveform of a driving pulse signal used in the method of driving a LED according to the present invention;

FIG. 6 is a plot of current as a function of time showing still another exemplary example of a waveform of a driving pulse signal used in the method of driving a LED according to the present invention;

FIG. 7 is a schematic diagram of a LED which is coated with a photoluminescent material and which is driven by the method according to the present invention;

FIG. 8 is a schematic plot of current as a function of time for explaining the effect of the photoluminescent material coated on the LED shown in FIG. 7;

FIG. 9 is a schematic plot of current as a function of time for explaining the principle of the method according to the present invention;

FIGS. 10 to 12 are plots of current as a function of time showing exemplary examples of waveform of driving pulse signals used in the method according to the present invention;

FIGS. 13 to 15 are circuit diagrams of the driving circuitries adapted to be used in the method according to the present invention;

FIG. 16(a)-(d) are circuit diagrams showing various LED array examples adapted to be driven by the method according to the present invention; and

FIGS. 17 to 18 are schematic diagrams for explaining how flickering phenomenon is prevented from occurring by using the photoluminescent material coated on a LED when the LED is driven by the method according to the present invention.

### DETAILED DESCRIPTION OF THE PREFERRED EMBODIMENTS

In the drawings, like numerals are used for like elements throughout.

An embodiment of the present invention will now be discussed with reference to the drawings.

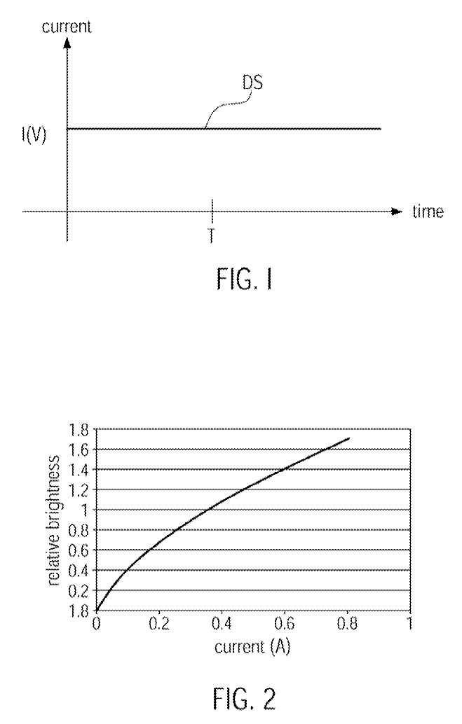

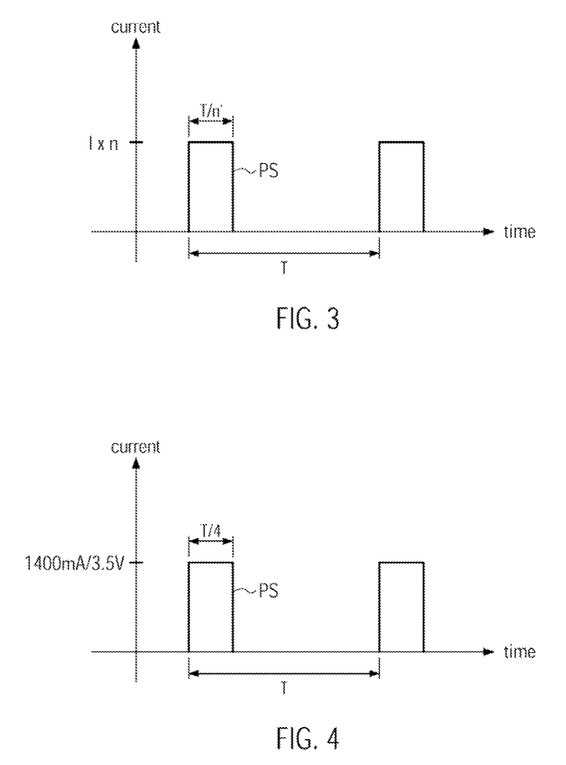

FIG. 1 shows a waveform of a conventional driving current signal DS for a light-emitting diode (LED) which is operated at a prescribed constant driving voltage of V and a prescribed constant driving current of I such that the prescribed power consumption P of the LED in a prescribed unit of time T is V×I. For a LED which is operated at a prescribed constant driving current of 350 milliAmperes (mA) and a prescribed constant driving voltage of 1 Volt (V) to emit light with an intensity of 30 illuminance (1×), as the current value of the driving current signal DS is increased, the light intensity increases accordingly, based on the relationship between the current value of the driving current signal and the light intensity shown in FIG. 2. For example, if the current value of the driving current signal DS is doubled to 700 mA (=350 mA×2), the light intensity will approximately increase to 60 1×. However, the power consumption P of the LED in a unit of time T will also be doubled, that is 2 Watts (W)(=3.5V×700 mA). It should be appreciated that the LED having the characteristics shown in FIG. 2 is available in the market.

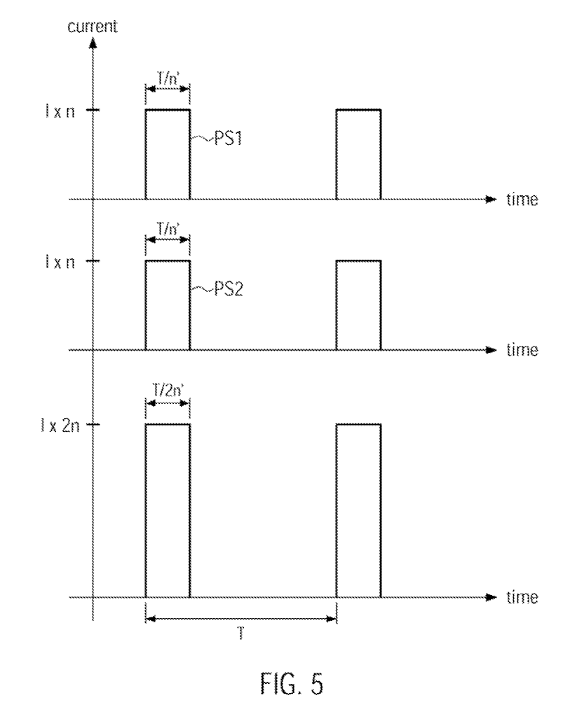

Referring to FIG. 3, a driving pulse signal PS used in the method of the present invention is shown. It can be seen from FIG. 2, the light intensity will increase as the current value of the driving current signal is increased. Therefore, in the method of the present invention, a driving pulse signal PS, the cycle of which is equal to the prescribed unit of time T, is provided to the LED. The peak value of each of the pulse signals PS is n times the current value of the signal DS, and the high voltage level duration of the pulse signal PS is (T/n′), wherein n and n′ are both positive integer excluding 0 and 1, and (n/n′)≦1. Therefore, during the high voltage level duration (T/n′), the power consumption of the LED is increased by n times because the current value of the driving pulse signal PS at its high voltage level is n times the current value of the signal DS, thereby increasing the light intensity n times. However, the total power consumption of the LED in the unit of time T is still equal to P (=V×(I×n)×1/n′), therefore, the total power consumption is kept unchanged.

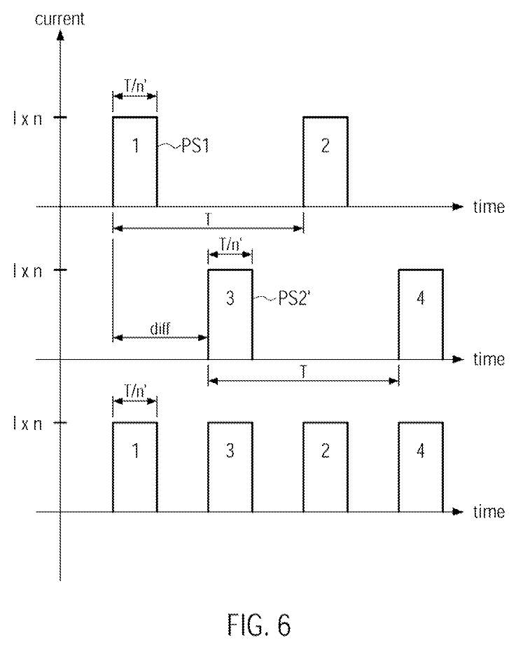

Referring to FIG. 4, if n is equal to 4, the current value of the current is 350 mA, the light intensity in the high voltage level duration T/n′ increases 4 times. However, the total power consumption is still 1 W. Therefore, the total power consumption is unchanged while the light intensity increases n times.

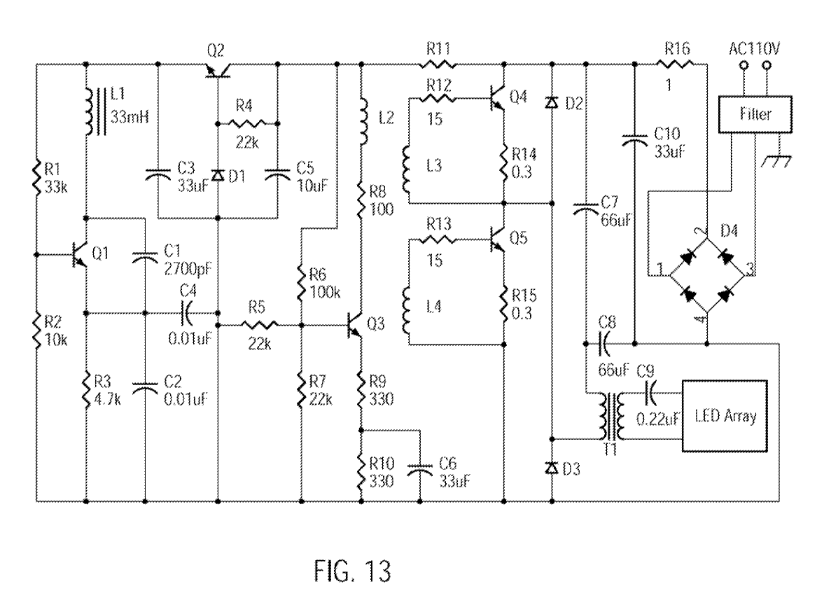

It should be noted that, although the light intensity will increase as the current value of the driving current signal is increased, the number of times is not unlimited. As shown in FIG. 9, when the magnitude of the current is increased to some extent, the LED enters to the breakdown state. At this time, the light intensity will not increase anymore, even though the magnitude of the current is continuously increasing. The selection of n is in relation to the high voltage level duration (T/n′), and the selection of the high voltage level duration (T/n′) is based on the effective slope of the current of the LED. In FIG. 9, as indicated by the thick broken lines, it is known that the LED is driven by a constant current value of 350 mA, only a portion (A) of the effective slope of the current is used. However, the whole effective slope (A+B) will be used in the present invention. Therefore, the intensity of the light emitted from the LED driven by the method of the present invention is substantially increased.

It should be noted that, the magnitude of the current in FIG. 9 is by way of example, the present invention is not limited thereto. On the other hand, the arrow indicates the loop formed by the rising edge, the high voltage level duration, and the falling edge of the pulse, that is, the conditions based thereupon the peak value of the pulse and the high voltage level duration is selected.

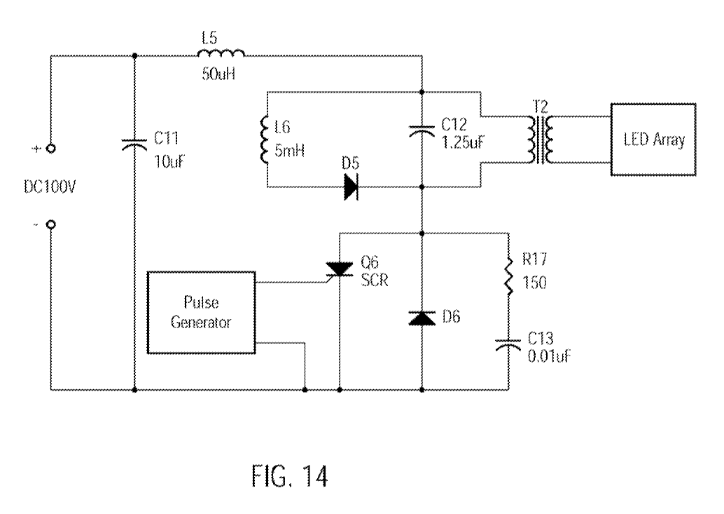

As described above, referring to FIG. 10, the LEDs are correspondingly driven by two identical driving pulse signals PS1,PS2 when the method of the present invention is used to drive two or more LEDs in series connection. Therefore, in comparison with FIG. 1, the light intensity will increase n×m times in the high voltage level duration (T/n′), wherein m is the number of LED and is 2 in the embodiment shown in FIG. 10.

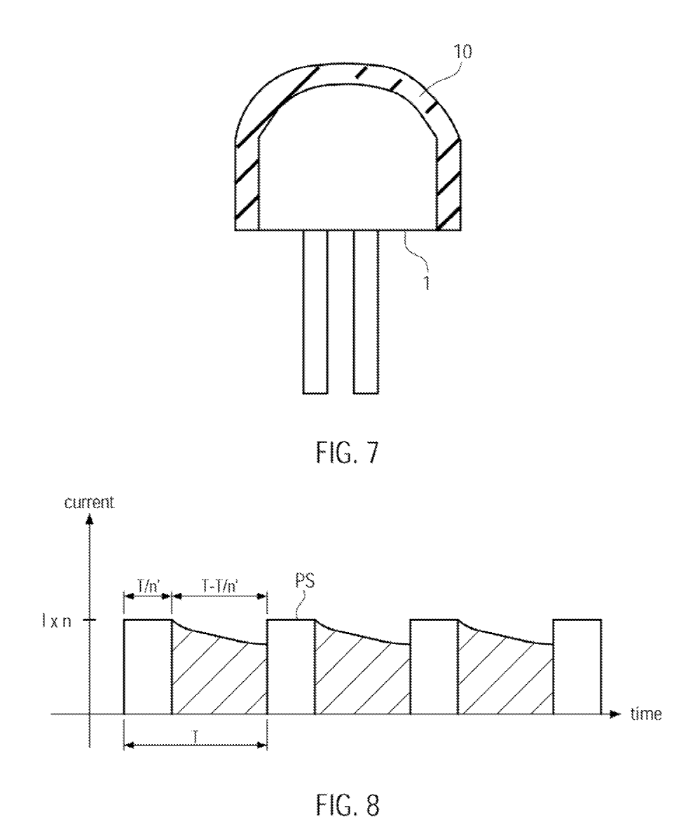

Referring now to FIGS. 5 and 12, the LEDs are correspondingly driven by two identical driving pulse signals PS1,PS2 when the method of the present invention is used to drive two or more LEDs in parallel connection. If the phases of the driving pulse signals PS1,PS2 are the same, that is, the driving pulse signals PS1,PS2 are synchronously provided to the corresponding LEDs, in comparison with FIG. 1, the light intensity will also increase n×m times in the high voltage level duration (T/n′).

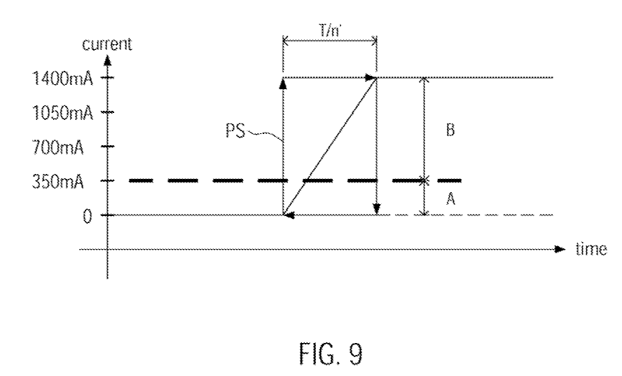

Referring now to FIGS. 6 and 11, the LEDs are correspondingly driven by two driving pulse signals PS1,PS2′ having different phases. The phases of the driving pulse signals PS1,PS2 are different, but the peak value and the cycle time are the same. The phase difference (diff) between the driving pulse signals PS1 and PS2′ can be selected depending on what is needed.

For n=4 and n′=8, the power consumption of PS1 during the high voltage level duration (T/n′) is 1400 mA×3.5V□4 W, the power consumption of PS2′ during the high voltage level duration (T/n′) is 1400 mA×3.5V□4 W. Therefore, the power consumption of PS1 in a unit of time T is about 0.5 W, and the power consumption of PS2′ is about 0.5 W. Therefore, two parallel-connected 1400 mA currents can increase 8 W slope and the light intensity, but the power consumption in a unit of time T is still about 1 W.

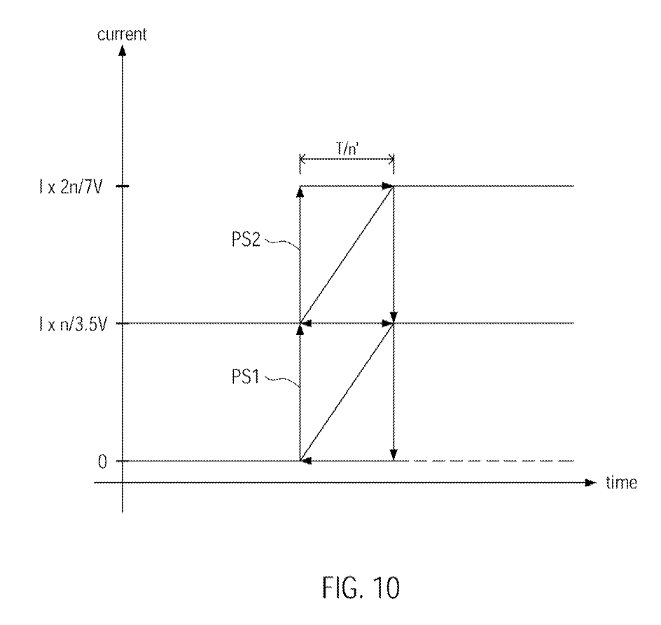

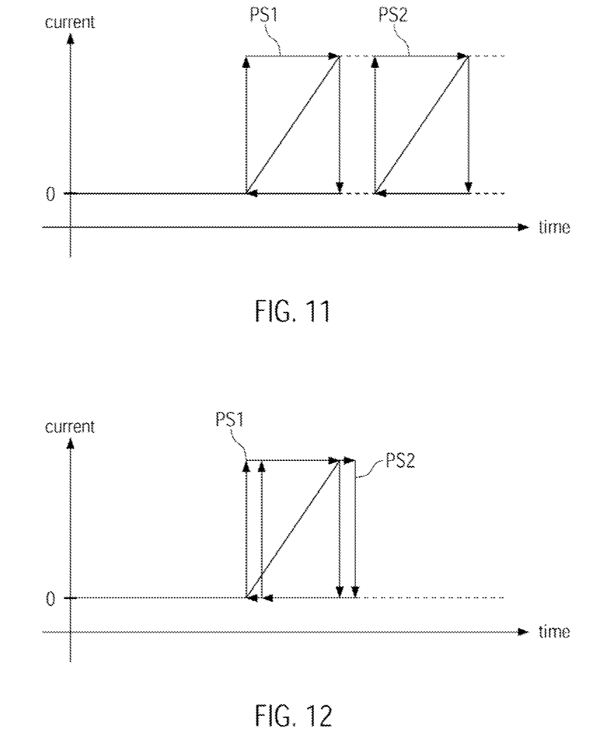

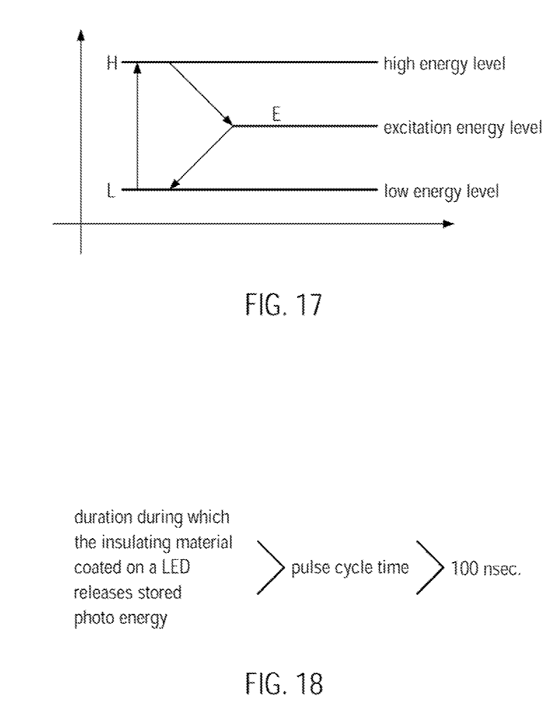

Referring to FIGS. 7, 8, 17 and 18, in order to prevent flickering phenomenon from occurring at the time of (T−(T/4)), the cap surface of the LED is preferably coated with an photoluminescent material, such as a phosphorescent or fluorescent material, which can absorb the ambient light and emit the absorbed light, such that the photoluminescent material will emit the light absorbed during the high voltage level duration (T/4) during the low voltage level duration (T−(T/4)). As shown in FIG. 8, the shadow portion is the low voltage level duration (T−(T/4)) during which the photoluminescent material releases the stored photo energy. It should be noted that, the intensity of light emitted from the photoluminescent material is about 80% of that from the LED. As shown in FIG. 17, the low energy level L is a level corresponding to the low voltage level of the driving pulse signal, the high energy level H is a level corresponding to the high voltage level of the driving pulse signal, and the excitation energy level E is a level above which the LED emits light. A cycle from the low energy level to the high energy level, from the high energy level to the excitation energy level, and from the excitation energy level total takes 100 nsec. It should be noted that, when the driving pulse signal transits from the low voltage level to the high voltage level, the LED emits light, and the photoluminescent material on the LED absorbs and stores the photo energy from the emitted light. When the driving pulse signal transits from the high voltage level to the low voltage level, the LED will cease to emit light after down from the excitation energy level E to the low energy level L. In the meantime, the photoluminescent material will release the stored photo energy until the driving pulse signal transits from the low voltage level to the high voltage level. Therefore, in order to prevent flickering phenomenon from occurring at the time of (T−(T/4)), a condition that the duration during which the photoluminescent material coated on a LED releases stored photo energy is greater than the pulse cycle, and the pulse cycle is greater than 100 nsec., must be satisfy.

It should be noted that, the photoluminescent material may be doped with fluorescent powder or phosphorus powder. On the other hand, the LED shown in FIG. 7 is by way of example, the photoluminescent material may be coated on the lighting surface of any LED package.

Furthermore, in other embodiments, RC (resistance-capacitance) circuitry is used to prevent flickering phenomenon from occurring, either instead of the photoluminescent material or in addition to the photoluminescent material. The capacitor is charged every on-cycle and then discharges through the LED(s) during the off-cycle.

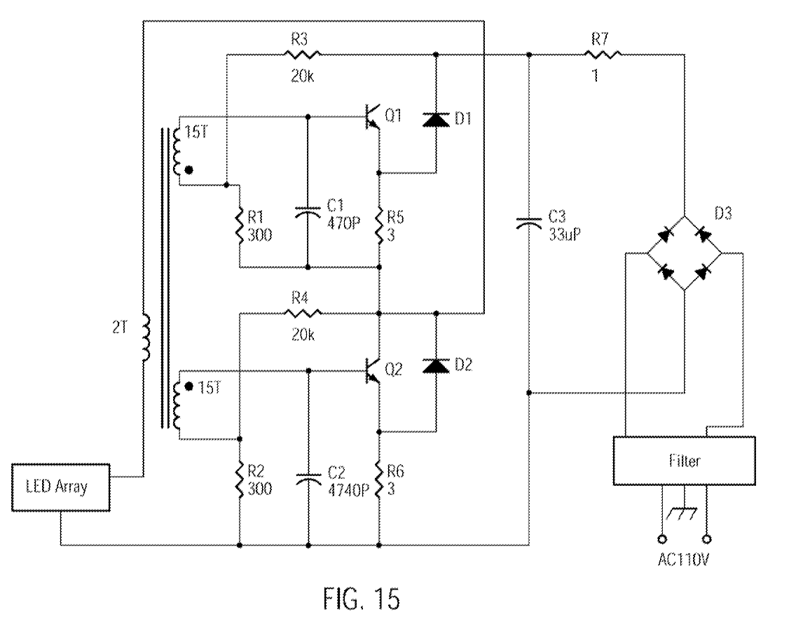

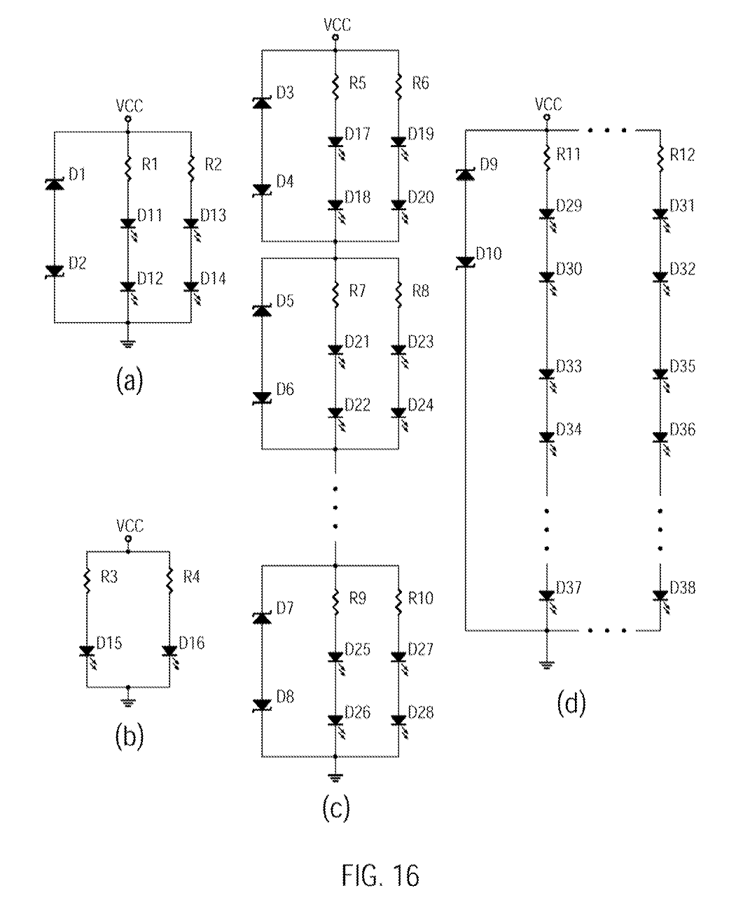

FIGS. 13 to 15 are three LED driving circuitry examples that are adapted to be used in the present invention. FIG. 16 is a schematic diagram showing various LED array examples adapted to be driven by the method according to the present invention.

Additionally, in order to further prevent the flickering phenomenon from occurring, the frequency of the driving pulse signal is set to 32 Hertz (Hz) or greater.

The present examples and embodiments are to be considered as illustrative and not restrictive, and the invention is not to be limited to the details given herein, but may be modified within the scope and equivalence of the appended claims.

While this invention has been particularly shown and described with references to preferred embodiments thereof, it will be understood by those skilled in the art that various changes in form and details may be made therein without departing from the scope of the invention encompassed by the appended claims.

What is claimed is:

1. A method for driving a light emitting diode (LED), comprising the steps of:
supplying said LED with a driving pulse signal at a cycle equal to a unit of time, said driving pulse signal having a peak value equal to n times of the current value and a duration of T/n′, wherein n and n′ both are positive integer excluding 0 and 1, and n/n′≦1.

2. A method according to claim 1, further comprising the step of:
coating a lighting surface of said LED with an photoluminescent material which absorbs ambient light and emits absorbed light, such that the photoluminescent material will emit the light absorbed during the pulse duration time (T/4) during the pulse intermittent time (T−(T/4)).

3. A method according to claim 2, wherein said photoluminescent material is doped with phosphor powder.

4. A method according to claim 2, wherein said photoluminescent material is doped with fluorescent powder.

5. A method according to claim 1, in the step of supplying driving pulse signal, said LEDs are serially connected, such that the light intensity of said LEDs will be increased by n×m times during the pulse duration time T/n′, wherein m is the number of said LEDs and is a positive integer excluding 0.

6. A method according to claim 1, in the step of supplying driving pulse signal, said LEDs are connected in parallel, said driving pulse signal received by each of said LEDs has a difference phase.

7. A method according to claim 1, in the step of supplying driving pulse signal, said LEDs are connected in parallel, said driving pulse signal received by each of said LEDs has a same phase, such that during the pulse duration time, the light intensity of said LEDs will be increased by n×m times, wherein m is the number of said LEDs and is a positive integer excluding 0.

8. A method according to claim 1, in the step of supplying driving pulse signal, said driving pulse signal has a frequency of at least 32 Hz.

9. A method according to claim 1, wherein when the LED is operated at a prescribed constant driving voltage and a prescribed constant driving current such that the prescribed power consumption of said LED in a prescribed unit of time is the prescribed constant driving voltage times the prescribed constant driving current.

10. A method according to claim 1, wherein the light intensity is increased by n times while the power consumption is the same.

11. A system, comprising
at least one LED; and
a circuit for driving the LED that supplies the LED with a driving pulse signal at a cycle equal to a unit of time, said driving pulse signal having a peak value equal to n times of the current value and a duration of T/n′, wherein n and n′ both are positive integer excluding 0 and 1, and n/n′≦1.
